(19) United States
(12) Patent Application Publication
(10) Pub. No.: US 2026/0051321 A1
(43) Pub. Date: Feb. 19, 2026

(54) Intelligent Assistant for a Motor Vehicle

(71) Applicant: Bayerische Motoren Werke Aktiengesellschaft, Muenchen (DE)

(72) Inventors: Adnan BEKAN, Muenchen (DE); Christian MUEHLBAUER, Muenchen (DE); Haonan QIU, Ulm (DE); Christian SUESS, Vierkirchen (DE)

(21) Appl. No.: 19/291,708

(22) Filed: Aug. 6, 2025

(30) Foreign Application Priority Data
Aug. 14, 2024 (DE) 10 2024 123 259.5

(51) Int. Cl. G10L 15/22; B60R 16/023; G05B 13/02; G07C 5/02; G10L 15/183

(52) U.S. Cl. CPC G10L 15/22; B60R 16/0231; G05B 13/027; G07C 5/02; G10L 15/183; G10L 2015/223; G10L 2015/228

(57) ABSTRACT

A method for controlling a motor vehicle includes steps of: recording a spoken utterance of a person on board the motor vehicle, wherein the utterance includes a control instruction that relates to an aspect of a driving state of the motor vehicle and wherein information that relates to the driving state of the motor vehicle is stored in data middleware; determining, via a large language model, a database query to determine the aspect in a graph-based query language on the basis of the utterance; determining the aspect of the driving state on the basis of the database query via the data middleware; and executing the control instruction taking into account the aspect of the driving state.

### CROSS REFERENCE TO RELATED APPLICATION

This application claims priority under 35 U.S.C. § 119 from German Patent Application No. DE 10 2024 123 259.5, filed Aug. 14, 2024, the entire disclosure of which is herein expressly incorporated by reference.

### BACKGROUND AND SUMMARY OF THE INVENTION

The present invention relates to an information system on board a motor vehicle. In particular, the invention relates to the control of a speech-enabled intelligent assistant on board a motor vehicle.

A function of a motor vehicle may be controlled by voice command. For this purpose, a spoken utterance of a person on board may be recorded and evaluated and a function that is assigned to a recognized voice command may be triggered accordingly.

A meaning of the utterance may depend on a context in which it was made. By way of example, the voice command “Please open my window” may relate to the window of the motor vehicle that is closest to the speaker. Customary speech processing is not able to determine such a context because it lacks information.

Speech processing may be carried out by means of a large language model (LLM), which already has a certain knowledge of the world. However, information relating specifically to the motor vehicle or the speaker is also not available in this case. Furthermore, training an LLM may be very laborious, and it can therefore be difficult to add new functions to a trained speech processing system.

One object on which the present invention is based is to provide an improved technique for controlling a motor vehicle on the basis of a spoken control instruction. The invention achieves this object by means of the subjects of the independent claims. Dependent claims provide preferred embodiments.

A method for controlling a motor vehicle comprises steps of recording a spoken utterance of a person on board the motor vehicle; wherein the utterance comprises a control instruction that relates to an aspect of a driving state of the motor vehicle; wherein information that relates to the driving state of the motor vehicle is stored in data middleware; determining, by means of a large language model, a database query to determine the aspect in a graph-based query language on the basis of the utterance; determining the aspect of the driving state on the basis of the database query by means of the data middleware; and executing the control instruction taking into account the aspect of the driving state.

Data middleware is able to receive and store information that indicates a driving state of the motor vehicle from a multiplicity of sources. The driving state may be determined dynamically at any time on the basis of the stored information. In particular, an aspect of interest of the driving state is able to be determined by virtue of an engine linking relevant information together appropriately. Exemplary aspects of the driving state may comprise, for instance, a driving speed, a geographical position or a seat occupancy on board the motor vehicle. The complete driving state may be determined by the totality of all of the available information. As will be explained in even more detail below, the data middleware may also be implemented in a distributed manner, wherein part of the middleware runs on an apparatus outside of the motor vehicle.

The LLM may analyze the utterance of the person and recognize the control instruction. Furthermore, the LLM may determine the aspect of the driving state that is required to select or parameterize the control instruction and provide a suitable query.

The graph-based query language may query content from a predetermined description system, for example from the Resource Description Framework (RDF). This allows logic statements to be formulated about any things in a database. The query language may in particular comprise SPARQL (SPARQL Protocol And RDF Query Language). This allows an aspect of the driving state to be discovered by way of a suitable query.

A wider range of control instructions may advantageously be supported. A control instruction may be provided by the person in natural language in an improved manner. Indications about a context or an aspect of the driving state that are embedded in the control instruction may be recognized and resolved. An intention of the person may be determined in an improved manner and the verbal control instruction may be recognized quickly and correctly in an improved manner. The intended instruction may be executed directly and accurately.

In one preferred embodiment, the database query is written to a request list of the data middleware; and a response to the database query is written to the request list. The list may be subscribed to by a database engine that performs the database query on the data of the data middleware. Artifacts of the data middleware may be readable, writable and/or able to be subscribed to, allowing any entities to communicate via an object, for example via a list. An asynchronous exchange may therefore be implemented, in which a transmitter and a receiver are dynamically connected to one another in an improved manner.

Similarly, the control instruction may be written to a request list of the data middleware; and the current driving state may be adapted to the control instruction. An appropriate agent may be provided to execute control instructions in the request list. Tasks such as a plausibility or security check may be implemented by the agent.

The database query may be determined on the basis of a manifest. The manifest may describe the database queries that are possible, how certain aspects of the vehicle state may actually be determined, and the function that should be called to obtain certain information. The manifest is preferably in text form and it may therefore be processed by the LLM. This also allows the manifest to be easily managed and, if necessary, checked for consistency by a human. The manifest may be easily modified, expanded, or replaced. It is therefore possible to easily upgrade or improve a new function or control instruction. A control instruction that is outdated or has proven unsafe may be easily removed.

Further preferably, the manifest comprises a collection of predetermined database queries. A database query may have an aspect of the vehicle state associated therewith, which is able to be determined by means of the query. The collection may be created or maintained by one or more experts. By way of example, a domain expert may contribute knowledge about the motor vehicle and the properties thereof. A knowledge engineer may provide knowledge about processing information and determining an issue on the basis of information stored in a database. The experts may together provide valuable database queries that may be used universally and efficiently to determine aspects of the vehicle state.

In a further embodiment, the manifest comprises a generic endpoint, which, however, returns different responses from the LLM depending on the different SPARQL payload.

In another embodiment, the database query is determined dynamically. For this purpose, the query may be formulated on the basis of the aspect of interest at the moment at which a response is desired. Further preferably, the database query is determined by means of a large language model. This may be carried out by means of the LLM mentioned above or a further LLM that is separate thereto. The LLM may be trained to determine the database query in a predetermined graph-based query language, in particular SPARQL.

According to a further aspect of the present invention, a system for controlling a motor vehicle comprises an input apparatus for recording a spoken utterance of a person on board the motor vehicle; wherein the utterance comprises a control instruction that relates to an aspect of a driving state of the motor vehicle; data middleware in which information that relates to the driving state of the motor vehicle is stored; a large language model (LLM) that is configured to determine a database query to determine the aspect in a graph-based query language on the basis of the utterance; and a query engine for the data middleware. In this case, the query engine is configured to determine the aspect of the driving state on the basis of the database query; and an execution apparatus for executing the control instruction taking into account the aspect of the driving state.

The system is preferably configured to partly or fully carry out a method described herein. For this purpose, the system may comprise a processing apparatus that is preferably of electronic design and may comprise, for example, an integrated circuit, a programmable logic chip or a programmable microcomputer. The method may be implemented in the form of a configuration or as a computer program product having program code means for the processing apparatus. The configuration or the computer program product may be stored on a computer-readable data carrier. Features or advantages of the method may be transferred to the device or vice versa.

The LLM may be of multimodal design and work directly on acoustic data that are sampled by a speaker. Alternatively, a speech-to-text conversion may be provided to convert acoustic data into text data, which may then be provided to a text-based LLM.

Data middleware may be implemented on a plurality of processing systems. Information may be regularly correlated between the processing systems. One processing system may be on board the motor vehicle and another may be mounted outside. A further processing system may also be mobile and, for example, run on a mobile device. It may therefore be irrelevant where the mobile processing system is currently located. Information may be exchanged at different rates, depending on the quality of a communication link. If no communication is currently possible, the correlation may be suspended.

The processing systems may have the same interfaces to work with data of the data middleware. In particular, objects of the data middleware may be accessed in a uniform manner. The processing system on which a read or write service is located may be irrelevant.

By way of example, the person could thus provide a verbal control instruction on their mobile device, which performs a language-to-text conversion and writes the result to an object of the data middleware. By way of example, the LLM could be located at a location remote from the motor vehicle, such as in a computing center. The LLM could extract the textual control instruction from the object and write one or more database queries to another object of the data middleware. A database engine could run the queries and write results back to the object. An agent on board the motor vehicle could collect the results and parameterize a control function with the results to achieve the effect desired by the person. The objects are hereby synchronized between the individual processing systems transparently by the data middleware.

The query engine may implement a knowledge graph (KG). The KG may comprise a stream reasoner that performs ontology-based reasoning. In a further embodiment of the invention, in addition to the ontologies, rules may also be provided. In this case, stream reasoning may also be performed on the basis of rules. The knowledge graph also preferably contains a query engine for Graph Query Language, in this case for example SPARQL. Said query engine allows new SPARQL queries to be added statically and at runtime, and dynamically provides an API endpoint for each dedicated SPARQL query, such as REST API and a generic SPARQL endpoint. The knowledge graph may also contain code logic that manages knowledge graph tasks, e.g. SHACL conversions, SPARQL API calls, etc.

The system may further comprise a large language model (LLM) that is configured to determine the database query dynamically.

According to yet another aspect of the present invention, a motor vehicle comprises a device that fully or partly implements a system described herein. It should be noted that the device does not necessarily comprise all of the elements of the system. However, an agent that executes the control instruction should preferably run on board the motor vehicle. The speaking person is also located in the area of the motor vehicle, usually even on board the motor vehicle, and so an element of the system that records the utterance is preferably also mounted in the area of the motor vehicle. In a further preferred embodiment, this element is fixedly attached to the motor vehicle and may comprise, for example, an interior microphone of the motor vehicle.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system; and

FIG. 2 illustrates a flowchart of a method.

### DETAILED DESCRIPTION OF THE DRAWINGS

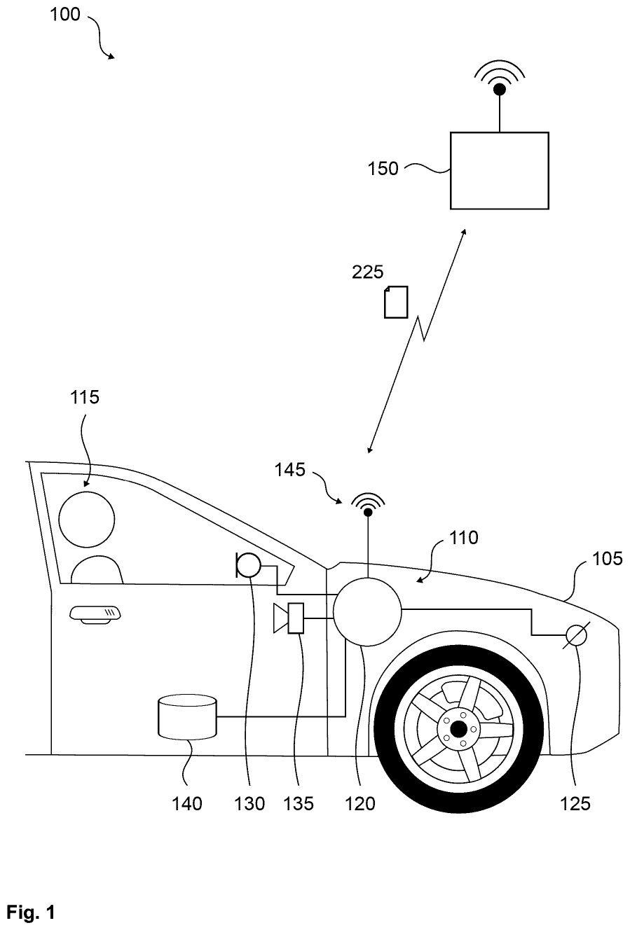

FIG. 1 shows a system 100. On board a motor vehicle 105, there is a device 110 that is configured to control a function of the motor vehicle 105 or a system or subsystem comprised thereby. It should be noted that the function may also comprise an item of information or the provision of an item of information that may be determined on the basis of available information in the context of the motor vehicle 105.

The device 110 preferably comprises a processing apparatus 120 that may be connected to an interface 125, by way of which a predetermined function of the motor vehicle 105 or one of the systems thereof may be controlled. A microphone 130 may be provided for recording a spoken utterance of the person 115. Further optionally, a loudspeaker 135 for providing acoustic feedback to the person 115 is shown. Information may be stored in a data memory 140. A communication apparatus 145 may be provided for communication with an external location 150.

The person 115 may make a spoken utterance in the motor vehicle 105, which may be evaluated by the device 110. In particular, the utterance may first be converted into text form. In response to the utterance, a function of the motor vehicle 105 may be controlled.

In one embodiment, the person 115 may give an instruction that may be interpreted in the context of the motor vehicle 105 or the driving state thereof. The recognized or parameterized instruction may then be executed automatically. In a further embodiment, a response to a question from the person 115 may also be provided. By way of example, the person 115 could say: “Hello BMW, please tell me whether I need wiper fluid”. The system 100 could then a) read out the current wiper fluid level, b) retrieve BMW-internal stored knowledge such as a user manual and c) query the weather for the next few days from an external service. On the basis of this information, it could be concluded that more snow is to be expected in the next few days and that the existing wiper fluid will no longer definitely be sufficient for several days, and respond with: “Yes, it is going to snow a lot over the next few days, please fill it up more.”

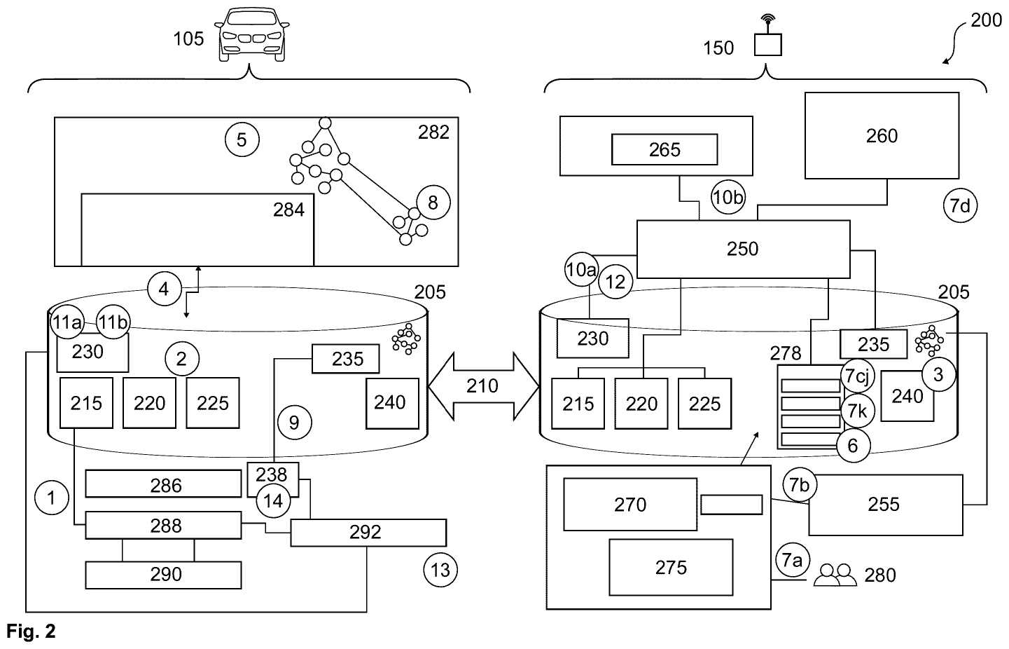

FIG. 2 shows a flowchart of a method 200 for controlling a motor vehicle 105. The system 100 is shown, from a functional point of view, with more details.

A respective instance of data middleware 205 is provided on board the motor vehicle 105 and at the external location 150, wherein the instances are coordinated bidirectionally with one another (as far as possible) in a process 210. The communication required for this purpose is preferably wireless, for example via mobile radio or WLAN.

Vehicle data 215, passenger data 220 and/or further data 225 may be found in data middleware 205. A request list 230 is in the form of an action and response list and is used for the communication of two external processes or services. An input text 235 may be provided by a user interface 238 that may be operated by the person 115 on board the motor vehicle 105. The user interface 238 may already convert the input text from an acoustic form to a text form. A mapping file 240 contains the information as to how data of the data middleware 205 may be converted from a tree format, for example JSON, into a graph format, for example RDF/OWL, and vice versa.

A first LLM 250, a second LLM 255 and a third LLM 260 are, for example, provided at the external location 115. It should be noted that two or more of the LLMs 250-260 may also be integrated with each other or may be of identical design. The first LLM 250 is configured for the determination of control instructions. The second LLM 225 is used for the static determination of SPARQL queries during runtime. The third LLM 260 is configured for the dynamic determination of SPARQL queries during runtime. Runtime is understood to mean the operation of the motor vehicle 105 in the context described herein, that is to say when the person 115 is on board and may make a spoken utterance comprising a control instruction. The third LLM 260 may provide a dynamic SPARQL query 265 to the first LLM 250.

A first ontology 270 and a first SPARQL query 275 may be stored in the data middleware 205. A manifest 278 may be specified for the first LLM 250, said manifest being able to contain, for example, an entry for static SPARQL queries, an entry for dynamic generic SPARQL queries, an entry for the conditions under which the third LLM 260 should be queried and/or an entry for required data points. An expert 280, for example a domain expert or a knowledge engineer, may provide entries to the manifest 278.

In the embodiment shown, a knowledge graph 282 is provided in the motor vehicle 105 and may comprise a JSON to RDF converter 284. The converter 284 may be configured to format content according to JSON and may comprise an RDF to JSON converter.

In order to control the motor vehicle 105, an execution engine 286 is provided that is able to communicate with an on-board electrical system 290 of the motor vehicle 105 via a vehicle API gateway 288 (cf. interface 125). One or more control devices may be connected to the on-board electrical system 290 and may carry out a control instruction and control a function of the motor vehicle 105. A function call manager 292 may convert a control instruction into corresponding control of the motor vehicle 105.

The method 200 will now be explained on the basis of an illustrative example. Steps of the method 200 that are mentioned as examples are shown in circles in FIG. 1.
Step 1: Data from vehicle sensors, actuators or interfaces are converted into a standardized vehicle data model such as VSS via the vehicle API gateway 288 and written to the data middleware 205, so that it always contains the most up-to-date version of the vehicle on-board electrical system data.
Step 2: Personal data 215 of a person 115 on board the motor vehicle 105 and further data 225 are written to the data middleware 205, either from sensors or applications in the motor vehicle 105 (e.g. camera recognition) or from the cloud or the external location 115 (e.g. customer data such as age and name)
Step 3: The mapping file 240 (in this case SHACL) contains the information as to how data middleware data in a tree format (in this case JSON) is able to be converted into a graph format (in this case RDF/OWL) and vice versa. For this purpose, SHACL replicates an ontological concept (class or attribute) for each data point using sh:targetClass and sh:path.
Step 4: Using the mapping file 240, vehicle, passenger and other data 215-225 are converted into the graph format and materialized within the knowledge graph 282 as triples (in this case RDF/OWL). This is preferably carried out in real time after there have been data changes in the data middleware 205. In this case, this is done using the JSON to RDF converter, which operates bidirectionally. Said JSON to RDF converter is connected to the data middleware 205, for example via WebSocket.
Step 5: Representations of vehicle, personal and other semantic concepts and data are then available in a graph format, for example A-Box and T-Box. The A-Box definitions are taken from the SHACL file 240 and the T-Box are the materialized facts of the knowledge graph 282.
Step 6: The first LLM 250 is provided with the following information:
   a) Vehicle functions that may be performed via the API gateway 288, such as changeSeatHeating(temperature, seatnumber), for example. This is done, for example, by adding a natural-language function API description, as is described for Open AI function call, for example. Further entries into the manifest 278 are described in subsequent steps.
Step 7a=stage 1: The domain expert 280 would like to make the already existing motor vehicle 105 more intelligent and therefore provides a more intelligent function that may be called by the first LLM 250 in a later step, e.g. “query the age of all the passengers sitting in the car, including their seat number”. Together with a knowledge engineer 280, they create a SPARQL 1 query in text format plus required T-Box concepts (if not already present in the knowledge graph 282) that are already represented in SHACL (otherwise, the new RDF triples are not able to be created on the basis of the data middleware data). The SPARQL 1 query is written in text format to the data middleware 205 in order to be synchronized with the motor vehicle 205. Finally, a manifest entry must be made for the first LLM 250 in order for it to be informed about the new SPARQL 1 function.
Step 7b=stage 2a: Instead of the knowledge engineer 280 and the domain expert 280 manually creating SPARQL queries and A-Box concepts, the second LLM 255 is now tasked with this. The second LLM 255 is an expert in creating SPARQL queries and A-Box concepts in general (due to the request to fine-tune general examples beforehand) and knows about available concepts and materialized facts in the vehicle knowledge graph by virtue of synchronizing them from the motor vehicle 105 to the cloud 150 via the data middleware 205 and also making them available to the second LLM 255. The rest is the same as in step 7a (which corresponds to stage 1)
Step 7ci=stage 2b: While the only difference between stage 1 and stage 2a is that the second LLM 255 performs the manual (static) operation of the domain expert 280 and the knowledge engineer 280 (the rest of the process is the same), stage 2b operates in a slightly different and more generic manner. Equivalent: The third LLM 260 is (as with the second LLM 255) an expert in creating SPARQL queries and A-Box concepts in general (due to the request to fine-tune general examples beforehand) and knows about available concepts and materialized facts in the vehicle knowledge graph by virtue of synchronizing them from the motor vehicle 105 to the cloud 150 via the data middleware 205 and also making them available to the third LLM 260. The difference: the third LLM 260 may be called by the first LLM 250 during runtime of the motor vehicle 105.
Step 7cj: The first LLM 250 must know when to call the third LLM 160 to create a dynamic SPARQL query. This may be determined by adding a manifest entry of the LLM3 API to the LLM1 manifest 278.
Step 7ck: In addition, the first LLM 150 must know where to transmit the query created dynamically (in a subsequent step 10b). For this reason, a generic SPARQL endpoint of the knowledge graph 282 is also added to the manifest 278 in this case.
Step 8: Stage 1 and stage 2a: The SPARQL 1 query is called by the knowledge graph 282 and a new endpoint is provided, e.g. via REST. If new T-Box concepts are required for the SPARQL query 1, they are created in the same way as in step 4. The SPARQL 1 endpoint is now ready to be called. Important: This step is not yet the execution of the query, it just makes the knowledge graph 282 aware and able to add static SPARQL functions that are new and able to be called (e.g. during the startup phase). This step does not exist for stage 2b because it is not needed since the SPARQL payload data are created dynamically and, after the natural-language entry of the person 115, are described as in the following steps.
Step 9: An example (use case) now begins. The person 115 gives a verbal control instruction to their motor vehicle 105: “Hey BMW, please activate the seat heater for my child”. First of all, it is unclear which seat the child is sitting on, and so the assigned seat heater is not able to be specified. Furthermore, the specification “my” still needs to be clarified, and the specification “child”may also need interpretation.

The user interface 238 converts the utterance into text that is synchronized with the cloud 150 via the data middleware 205, where it is forwarded to the first LLM 250.
Step 10a: Stage 1 and stage 2a: The first LLM 250 knows, on account of the general knowledge thereof and on the basis of the input manifest 278, that, with a SPARQL1 query, it must first find out where the baby is sitting and then call the changeSeatHeating (temperature, seat number) function at the vehicle API gateway 288. In order to achieve this, in this step, the first LLM 250 responds to the SPARQL1 query that is written by a code to an LLM1 action & response list 230, which represents an object, which is readable, writable and/or able to be subscribed to, in the data middleware 205, like the other artifacts in the data middleware 205, with the first function call (according to the predefined structure in the manifest file 278).
Step 10b: Stage 2b: The LLM1 knows, on account of the general knowledge thereof and on account of the input manifest 278, that it must first call the third LLM 260 in order to request a suitable, dynamically created SPARQL query that finds out where the baby is sitting.

In a third LLM 260 that is functioning very well, the query created dynamically is the same as would be created manually by an expert 280 in phase 3.1 or by the second LLM 255 in phase 3.2a. The dynamically created SPARQL query is sent back to the first LLM 250, which receives it and creates a new function call in the action & response list 230 of the first LLM 250 according to the manifest 278, in order to now call the generic SPARQL endpoint in the knowledge layer.
Step 11a: Stage 1 and stage 2a: Since the knowledge graph 282 subscribes to the action & response list 230 of the first LLM 250, it is triggered, knows that it must call the SPARQL1 query, and then transmits the response back to the first LLM 250 by writing the response to the action & response list 230.
Step 11b: Stage 2b: When the knowledge graph 282 subscribes to the action & response list 230, it is triggered, knows that it must call the generic SPARQL endpoint with the SPARQL query payload generated previously by the third LLM 260 (it is possible to imagine a function argument payload), and then transmits the response back to the first LLM 250 by writing the response to the LLM1 action & response list 230.
Step 12: The first LLM 250 receives the response from call 1 and calls function 2 by responding again on the basis of the structured function description from the manifest 278 for the changeSeatHeating( ) function
Step 13: The function call manager 292 also subscribes to the LLM1 action and response list 230. It is therefore triggered and calls the changeSeatHeating( ) function.
Step 14: After receiving the “confirmation” from the on-board electrical system 290 that the activation was successful, the function call manager 292 optionally transmits a short information text to the user interface 238, which is converted into a voice output, e.g. “The seat heater is now activated for your child.” This confirmation text may also be created by the first LLM 250 (for reasons of neat architectural representation, it is not shown here). This concludes the selected use case.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### Reference Signs

100 System
105 Motor vehicle
110 Device
115 Person
120 Processing apparatus
125 Interface
130 Microphone
135 Loudspeaker
140 Data memory
145 Communication apparatus
150 External location
200 Method
205 Data middleware
210 Synchronization
215 Vehicle data
220 Passenger data
225 Further data
230 Request list
235 Input text
238 User interface
240 Mapping file
250 LLM 1 for determination of control instructions
255 LLM 2 for static determination of SPARQL queries during runtime
260 LLM 3 for dynamic determination of SPARQL queries during runtime
265 Dynamic SQL query
270 Ontology 1
275 SPARQL query
278 Manifest
280 Expert
282 Knowledge graph
284 JSON to RDF converter
286 Execution engine
288 Vehicle API gateway
290 Vehicle on-board electrical system
292 Function call manager

What is claimed is:

1. A method for controlling a motor vehicle, comprising the steps of:
recording a spoken utterance of a person on board the motor vehicle;
wherein the utterance comprises a control instruction that relates to an aspect of a driving state of the motor vehicle;
wherein information that relates to the driving state of the motor vehicle is stored in data middleware;
determining, via a large language model, a database query to determine the aspect in a graph-based query language on the basis of the utterance;
determining the aspect of the driving state on the basis of the database query via the data middleware; and
executing the control instruction taking into account the aspect of the driving state.

2. The method according to claim 1, wherein
the database query is written to a request list of the data middleware; and
a response to the database query is written to the request list.

3. The method according to claim 2, wherein
the control instruction is written to a request list of the data middleware; and
the current driving state is adapted to the control instruction.

4. The method according to claim 1, wherein the database query is determined on the basis of a manifest.

5. The method according to claim 4, wherein the manifest comprises a collection of predetermined database queries.

6. The method according to claim 1, wherein the database query is determined dynamically.

7. The method according to claim 6, wherein the database query is determined via a large language model.

8. A system for controlling a motor vehicle, the system comprising:
an input apparatus for recording a spoken utterance of a person on board the motor vehicle;
wherein the utterance comprises a control instruction that relates to an aspect of a driving state of the motor vehicle;
data middleware in which information that relates to the driving state of the motor vehicle is stored;
a large language model that is configured to determine a database query to determine the aspect in a graph-based query language on the basis of the utterance;
a query engine for the data middleware, wherein the query engine is configured to determine the aspect of the driving state on the basis of the database query; and
an execution apparatus for executing the control instruction taking into account the aspect of the driving state.

9. The system according to claim 8, wherein
the data middleware is implemented on a plurality of processing systems; and
information is regularly correlated between the plurality of the processing systems.

10. The system according to claim 8, wherein the query engine creates a knowledge graph.

11. The system according to claim 9, further comprising:
another large language model that is configured to determine the database query dynamically.

12. A motor vehicle comprising a device that implements at least part of a system according to claim 8.
